(19) United States
(12) Patent Application Publication
(10) Pub. No.: US 2018/0181860 A1
(43) Pub. Date: Jun. 28, 2018

(54) DERIVING MOVEMENT BEHAVIOUR FROM SENSOR DATA

(71) Applicant: SENTIANCE NV, Antwerpen (BE)

(72) Inventors: Frank VERBIST, Wolvertem (BE); Joren VAN SEVEREN, De Pinte (BE); Vincent SPRUYT, Antwerpen (BE); Vincent JOCQUET, Antwerpen (BE)

(21) Appl. No.: 15/739,605

(22) PCT Filed: Dec. 21, 2015
(86) PCT No.: PCT/EP2015/080800

§ 371 Date: Dec. 22, 2017

Related U.S. Application Data
(60) Provisional application No. 62/185,000, filed on Jun. 26, 2015.

(51) Int. Cl. G06N 3/04; G06N 3/08; B60W 40/09

(52) U.S. Cl. CPC G06N 3/0454; B60W 40/09; G06N 3/08; G06N 3/0445

(57) ABSTRACT

A method for estimating movement behaviour of a user of a mobile communication device by a neural network comprising one or more lower and one or more higher hidden layers. The method comprises a step of obtaining sensor data from sensors in the mobile device; a step of obtaining measurements related to a movement of the user; a step of labelling these measurements as weakly labelled data; pre-training the lower hidden layers to estimate the measurements from the first set of sensor data; a step of obtaining a second set of sensor data wherein movement behaviour of the user is labelled as labelled data; a step of training the higher hidden layers with the labelled data to estimate the movement behaviour of the user as said output.

### FIELD OF THE INVENTION

The present invention relates to machine learning, and more particularly to deep learning using neural networks for the analysis of the movement behaviour of a user based on raw sensor data.

### BACKGROUND OF THE INVENTION

The movement behaviour of a user can be described by a set of characteristics such as the mode of transportation of a transport session, the driving aggressiveness of a driving session, the walking pace or step count of a walking session, etc.

Traditional methods to measure these characteristics in order to estimate and summarize this movement behaviour require the user to wear specialized sensors or motion capturing devices. Nowadays most people carry a smartphone, and most smartphones contain sensors such as an accelerometer, gyroscope, magnetometer, compass, barometer and GPS, which could be used as a cheap and widely available alternative to these specialized sensors or motion capturing devices.

Some specific applications that exploit smartphone sensors, e.g. transport mode detection, already exist on the market. For example, both the Android OS and the Apple iOS continuously perform transport mode detection based on the smartphone's sensor readings. These applications are based on so called classifiers, made up of a set of rules. Machine learning algorithms then automatically generate these rules by processing a large amount of manually labelled data, i.e., sensor data which is manually related to a movement behaviour. Such automated generation of rules in machine learning is also referred to as training. The data used for the training is then referred to as training data.

In order to train the algorithms, the data needs to be labelled, i.e., the desired outcome of the set of rules must be added to a certain set of input data. For example, a stream of sensor readings is annotated or labelled with a label such as ‘walking’, ‘biking’, ‘car’, etc in order to indicate the mode of transportation. Machine learning algorithms use this labelled data to learn how to automatically predict the label and thus the outcome of a previously unseen data sample, e.g. a stream of sensor readings.

A problem with the above solution is that a large amount of such labelled data is needed in order to properly train the machine learning algorithms. The needed amount of labelled data further increases when prediction is needed for multiple movements and transport related classifications. Moreover, such manually labelled data is difficult and/or expensive to obtain, and it might even be practically impossible to manually label enough data to train a machine learning algorithm for predicting general movement behaviour.

Another problem is that typically distinct systems are provided for performing movement analysis. For example, systems for transport mode detection and driving event detection are treated as distinct systems. As a result, for each of them large amounts of manually labelled training data, is needed while the labelled data of one system cannot be reused for the other system.

### SUMMARY OF THE INVENTION

It is an object of the present invention to alleviate the above disadvantages and to provide a method and system for estimating, predicting or detecting movement behaviour from raw sensor data that can be trained from a limited or reduced set of labelled data.

According to a first aspect, this object is achieved by a computer-implemented method for estimating movement behaviour of a user of a mobile communication device by a neural network comprising one or more lower and one or more higher hidden layers. The method comprises the following steps:
Obtaining sensor data from one or more sensors in the mobile communication device.
Obtaining measurements related to a movement of the user.
Labelling the measurements as weakly labelled data with a first set of the sensor data.
Pre-training the one or more lower hidden layers to estimate the measurements from the first set of sensor data in order to estimate the movement of the user.
Obtaining a second set of the sensor data wherein movement behaviour of the user is labelled with the second set as labelled data.
Training the one or more higher hidden layers in the neural network with the labelled data to estimate the movement behaviour of the user as the output.

By the pre-training, it is learned how to fuse data streams from different sensors, how to remove noise and artefacts from the input data and how to calculate features that represent and abstract the raw sensor data in a meaningful manner. For the pre-training, no manually labelled data samples are needed, i.e., no data samples are needed that relate the sensor data directly to the movement behaviour of the user. As the weakly labelled data is highly correlated with the labelled data, during the pre-training an internal representation of the data that is needed for training the neural network with the labelled sensor data will be constructed. Therefore, the neural network can thus be accurately trained with a limited set of labelled data. The labelled data needs to relate the sensor data with the output of the neural network, i.e., directly with the movement behaviour. This labelled data may be manually labelled data, i.e., sensor data that is manually annotated with a label by a person. This manually labelled data is expensive and it is therefore an advantage that the neural network can be mostly trained by cheap weakly labelled data. Furthermore, by using a plurality of hidden layers, the neural network is able to automatically learn a hierarchical, sparse and distributed representation of the input data.

The training may further comprise training the one or more lower hidden layers in said neural network. This way the parameters of the lower hidden layers are further fine-tuned during the training resulting in a more accurate estimation of the movement behaviour.

According to an embodiment, the method further comprises:
Before the pre-training, stacking an output layer on top of the one or more lower hidden layers for calculating the movement of the user.
After the pre-training, removing the output layer and stacking the one or more higher hidden layers on the one or more lower hidden layers.

The output layer provides the estimated movement of the user after the pre-training. By removing this output layer, the estimated movement of the user is thus not fed to the higher hidden layer, but only the output of the pre-trained lower hidden layers. This has the advantage that a more abstract representation of the movement of the user is provided to the higher hidden layers.

More advantageously, after the pre-training also one or more top layers of the lower hidden layers may be removed. This allows to provide an even more abstract representation of the movement of the user to the higher hidden layer.

The sensors may for example comprise one of the group of an accelerometer, a compass and a gyroscope. Such sensors are commonly available on today's communication devices such as for example on smartphones and tablet computers.

The measurements may for example comprise at least one of the group of:
a speed measurement;
a throttle measurement of a throttle position of a transportation means operated by the user;
an engine's RPM (revolutions per minute) measurement.
   Such measurements can be easily obtained in an automated manner.

According to an embodiment, the estimating movement behaviour comprises estimating a driving event.

A driving event may for example correspond to one of the group of braking, accelerating, coasting, taking roundabout, turning and lane switching.

According to an embodiment, the estimating movement behaviour the detecting movement behaviour comprises detecting a transport mode of said user.

According to a preferred embodiment, the neural network is a deep neural network comprising at least two of the group of a long-short-term memory neural network component, a convolutional neural network component, and a feed forward neural network component as the lower and/or higher hidden layers.

The sensor data has a temporal nature. By using a recurrent neural network, previous outputs are fed back to the input in a next iteration. It is therefore an advantage that the system is able to learn both short and long range dependencies and relations between sensor data. For the prediction of mobile behaviour, this further avoids optimization difficulties such as the vanishing gradient problem. It is therefore an advantage that long-range dependencies in the sensor data can be modelled in an accurate way.

According to an embodiment the movement behaviour comprises a first and second type of movement behaviour. The higher hidden layers further comprise a first and second higher set of hidden layers outputting respectively this first or second type of movement behaviour as output. Both the first and second movement behaviour of the user is then labelled with the second set of the sensor data as respectively first and second labelled data. The training then comprises training the first and second higher set of the hidden layers with respectively the first and second labelled data.

It is thus an advantage that the pre-training step can be used for training a neural network that outputs two types of movement behaviour. In other words, the weakly-labelled data is reused for the training of the second higher set of hidden layers.

Training and pre-training may further comprise fine-tuning parameters of respectively the higher and lower hidden layers. This may further be performed in an iterative way.

According to a second aspect, the invention also relates to a computer program product comprising computer-executable instructions for performing the method according to the first aspect when the program is run on a computer.

According to a third aspect, the invention relates to a computer readable storage medium comprising the computer program product according to the second aspect.

According to a fourth aspect, the invention relates to a data processing system programmed for carrying out the method according the first aspect.

### BRIEF DESCRIPTION OF THE DRAWINGS

FIG. 1 illustrates a deep neural network for estimating a movement behaviour according to an embodiment of the invention.

FIG. 2 illustrates a deep neural network architecture according to an embodiment of the invention.

FIG. 3A to FIG. 3G illustrates deep recurrent neural network architectures according to various embodiments of the invention.

FIG. 4 illustrates steps for training a neural network for estimating a movement behaviour according to an embodiment of the invention.

FIG. 5A illustrates a neural network component according to an embodiment of the invention for estimating measured data from sensor input data after a pre-training step with weakly labelled data.

FIG. 5B illustrates a neural network component according to an alternative embodiment of the invention for estimating measured data from sensor input data after a pre-training step with weakly labelled data.

FIG. 6 illustrates a neural network comprising a generic and application specific neural network component for estimating a movement behaviour of a user from sensor input data.

FIG. 7 illustrates a neural network according to an embodiment of the invention after a pre-training and training step for estimating a movement behaviour of a user from sensor input data.

FIG. 8 illustrates a neural network according to an alternative embodiment of the invention after a pre-training and training step for estimating a movement behaviour of a user from sensor input data.

FIG. 9 illustrates a neural network according to an alternative embodiment of the invention after a pre-training and training step for estimating a movement behaviour of a user from sensor input data wherein a neural network component for driving event detection further takes external data as input.

FIG. 10 illustrates the neural network of FIG. 9 wherein a further neural network component for driving behaviour detection has been stacked on the neural network component for driving event detection.

FIG. 11 illustrates a neural network according to an embodiment of the invention wherein a first neural network component for driving event detection and a second network component for transport mode detection have been stacked on the neural network component according to FIG. 5B.

### DETAILED DESCRIPTION OF EMBODIMENT(S)

The present invention relates to a method and machine learning framework for estimating, predicting or detecting movement behaviour of a user of a mobile communication device. The invention also relates to a method for training such a framework without the need for large amounts of manually labelled training data.

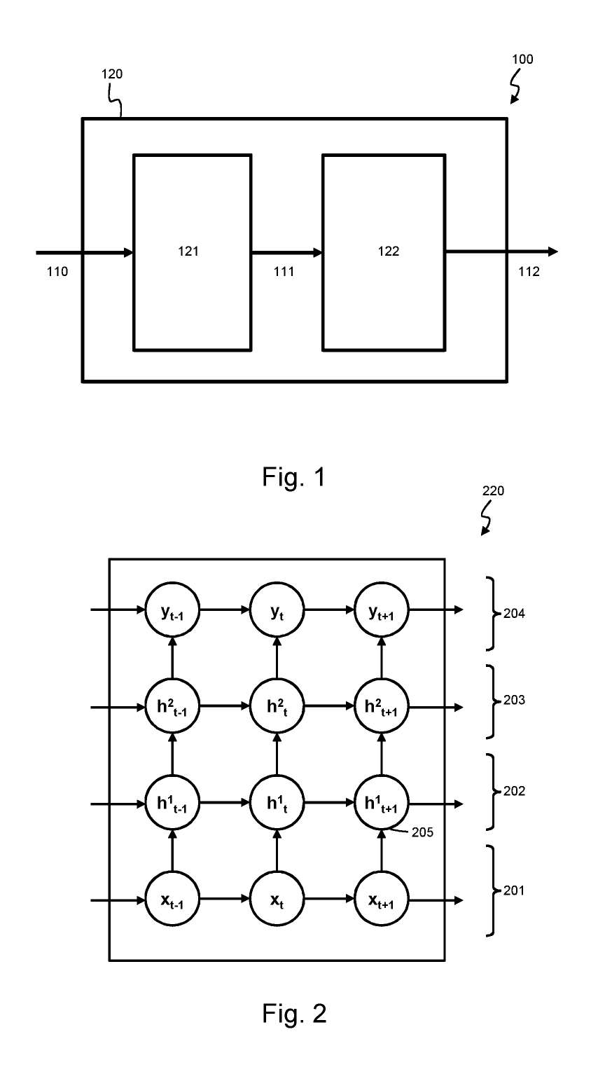

FIG. 1 illustrates a general overview of a machine learning framework 100 according to an embodiment of the invention. As input, the framework takes raw sensor data 110 from a mobile communication device of a user. The raw sensor data 110 is acquired from sensors in the mobile communication device, such as for example from an accelerometer, a compass and/or a gyroscope. As output 112, the framework 100 estimates a certain type of movement behaviour 112 of the user of the mobile communication device.

A first type of movement behaviour is for example driving behaviour which is characterized by assigning scores to discrete driving events such as but not limited to braking, accelerating, coasting, roundabout, turning, lane switching, driving over cobbles, driving over speed bumps, turning, accelerating and braking. These scores can be chosen to represent aggressiveness, traffic insight, legal behaviour, etc. In other words, the framework estimates driving events as output from the raw sensor data from which the driving behaviour of the user may then be derived.

A second type of movement behaviour is for example a transport mode of the user of the mobile communication device. Examples of transport modes are biking, walking, car—driver, car—passenger, train, tram, metro, bus, taxi, motorbike, airplane or boat.

Due to the temporal nature of the input sensor data 110 obtained from a mobile communication device, the framework 100 learns both short and long range dependencies and relations. For example, the framework will learn that a change in gyroscope magnitude is often preceded by a change in accelerometer magnitude which is the consequence of a braking operation performed by a user before turning when driving a car. Another example is that an accelerometer magnitude often exhibits a regular pattern when moving according to a certain walking pace.

To learn and apply these temporal dependencies, the framework 100 comprises a deep recurrent neural network 120. Deep recurrent neural networks are commonly known in the art and for example disclosed by Pascanu, Razvan, et al. in “How to construct deep recurrent neural networks.” arXiv preprint arXiv:1312.6026 (2013) and by Sutskever, Ilya, Oriol Vinyals, and Quoc VV Le in “Sequence to sequence learning with neural networks.”, Advances in neural information processing systems, 2014 and by Yann LeCun, Yoshua Bengio & Geoffrey Hinton in “Deep Learning”, Nature 521, 436-444 on 28 May 2015.

The framework according to the invention comprises a deep neural network 120 where multiple hidden layers are stacked on top of each other to increase the expressiveness of the neural network. In FIG. 1 the neural network 120 comprises a first lower set 121 of such hidden layers and a second higher set 122 of such hidden layers. In the description below, the first set 121 is also referred to as a first neural network component 121 and the second higher set 122 as the second or higher neural network component 122.

In a standard recurrent neural network or RNN, given an input sequence x=(x₁, x₂, . . . , x_{T}), the RNN computes the hidden vector sequence h=(h₁, h₂, . . . , h_{T}) and an output sequence y=y₁, y₂, . . . , y_{T}) by means of a recursive algorithm that feeds back previous outputs of hidden layers to the input of the hidden layer in its next iteration.

FIG. 2 illustrates an example of a deep recurrent network 220 comprising two hidden layers 202 and 203, i.e., a lower hidden layer 202 and a higher hidden layer 203. The vector Xₜ 201 represents the input of the network 220 and thus comprises the raw input sensor data from the mobile communication device. The vector Yₜ 204 represents the output of the network 220 and thus represents the estimated movement behaviour of the user. Stacking more than two of such hidden layers is often referred to as deep learning, and outperforms shallow neural networks. A deep neural network is able to automatically learn a hierarchical representation of the input data which is an advantage of the present invention. A hierarchical representation means that lower levels 202 of the model represent fine grained features, whereas the higher level layers 203 of the model automatically learn to aggregate this low level information into more abstract concepts. In the deep recurrent neural network of FIG. 2, each input sample Xₜ 201 and each output sample Yₜ 204 may be multi-dimensional vectors. The input sample 201 is then the raw sensor data as obtained from a user's mobile communication device, e.g., sensor data comprising both an accelerometer and gyroscope value. The output sample 204 is then the estimated or predicted movement behaviour of the user. Each hidden layer sample hⁿₜ may also be multidimensional, and the number of dimensions may differ for each hidden layer 202, 203.

Alternatively, instead of using a traditional deep recurrent neural network, extensions and variants such as the Long-Short-Term memory or LSTM recurrent neural networks may be used instead. LSTM recurrent neural networks are commonly known in the art and for example disclosed by Hochreiter, Sepp, and Jürgen Schmidhuber in Long short-term memory”, Neural computation 9.8, 1997, pg. 1735-1780. Traditional deep recurrent neural networks are difficult to train, due to optimization difficulties caused by the vanishing gradient problem as also acknowledged by Hochreiter, Sepp in “The vanishing gradient problem during learning recurrent neural nets and problem solutions.”, International Journal of Uncertainty, Fuzziness and Knowledge-Based Systems, 6.02 (1998): 107-116. As a result, traditional recurrent neural nets are only able to model short-range context in an adequate manner. An extension of RNNs that solves this problem by explicitly adding memory cells to the architecture, and that can model long-range dependencies as a result, are Long-Short term memory (LSTM) networks.

Alternatively to stacking hidden layers of the same type, e.g., all LSTM layers, to achieve depth in the network, other configurations may be used instead. Such alternatives include those with extra layers of a different type between the input 201 and the first hidden layer 202, those with extra layers between the last hidden layer 203 and the output 204, those with extra layers between each hidden node, those with connections between different hidden layers at different time steps, and combinations thereof. These extra layers may either be traditional feed-forward neural network layers, or variants such as the convolutional neural network (CNN), or combinations of both.

Whereas the recurrent neural network layers allow the system to learn temporal dependencies in the data, the feed-forward or convolutional neural network layers assist in generating meaningful and hierarchical feature representations. Since subsequent sensor data samples are strongly correlated, convolutional neural network layers are preferred for performing dimensionality reduction and feature description, feeding its outputs into the recurrent neural network.

Convolutional neural networks consist of convolutional layers and pooling layers. Convolutional layers perform feature extraction by calculating linear combinations of neighbouring samples before applying a non-linearity. Pooling layers perform subsampling in order to reduce the dimensionality of the data. Stacking convolutional and pooling layers results in a hierarchical feature description system.

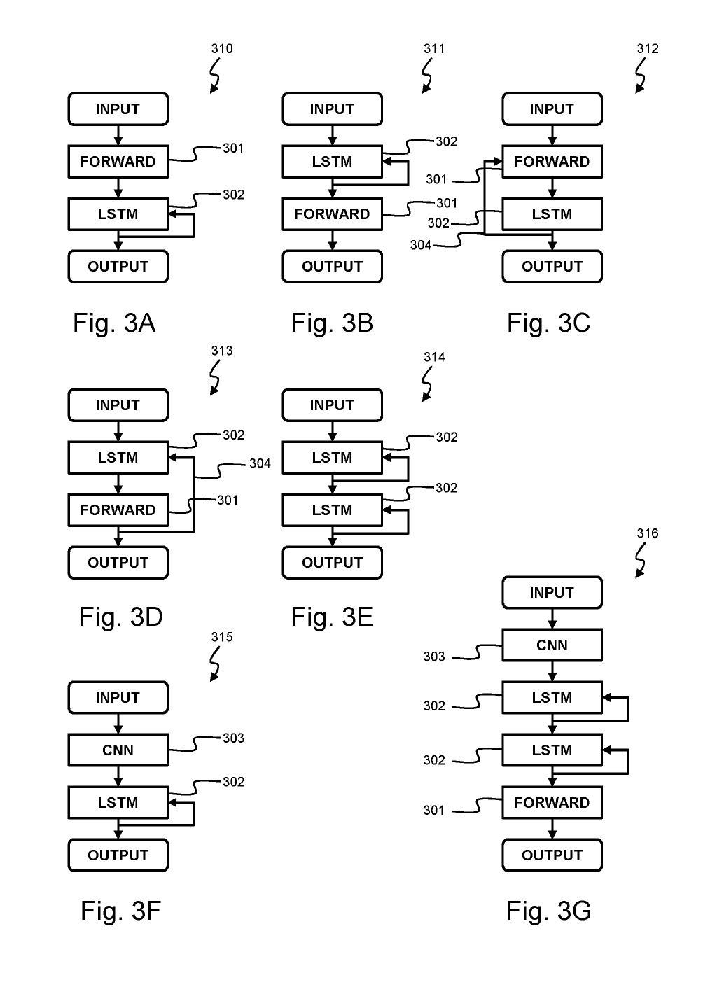

In FIG. 2 of the publication “Constructing Long Short-Term Memory based Deep Recurrent Neural Networks for Large Vocabulary Speech Recognition” by Li, Xiangang, and Xihong Wu in arXiv preprint arXiv: 1410.4281 (2014) retrievable from http://arxiv.org/pdf/1410.4281.pdf examples of stacking hidden layers to achieve depth in the network by adding LSTM-like hidden layers, CNN-like hidden layers or feed-forward-like hidden layers are disclosed. These examples are also shown in FIG. 3A to FIG. 3G. FIG. 3A and FIG. 3B show respectively a neural network 310 and 311 that combine an LSTM component 302 with a feed-forward component 301. Both the LSTM and feed-forward components 302, 301 may further comprise one or more hidden LSTM layers. The neural networks 312 and 313 of FIGS. 3C and 3D use the same components as FIGS. 3A and 3B but differ in the way the feed-back connection 304 from the LSTM component 302 is used. Instead of feeding back within the LSTM component 302 as in FIGS. 3A and 3B, in FIG. 3C, the hidden LSTM state is fed back to the feed-forward component 302 and in FIG. 3D the feed-forward output is fed back into the LSTM component. FIG. 3E a neural network 314 where multiple LSTM components 302 are stacked to achieve depth. In the neural network 315 of FIG. 3F a convolutional neural network or CNN 303 is used to process the data before feeding it into the LSTM 302. FIG. 3E shows a neural network 316 comprising a stacking of the neural networks 311 and 315 in order to achieve a deeper representation.

Each neuron 205 in each layer of the neural network 120, 220 performs a non-linear transformation to its input data before multiplying the result with a weight parameter and passing the output to the next layer. These weight parameters need to be fine-tuned during a training stage, by feeding-in labelled data, i.e. sensor data that is labelled with the expected output of the neural network. This way, after training, the output of the neural network architecture will reflect the expected outcome.

Before training, the parameters of the neural network are unknown, and usually set to a random value. By feeding in labelled data samples, observing the output, and adapting the parameters based on the difference between the observed output and the expected output, the parameters are then fine-tuned recursively, until the output reflects what is expected.

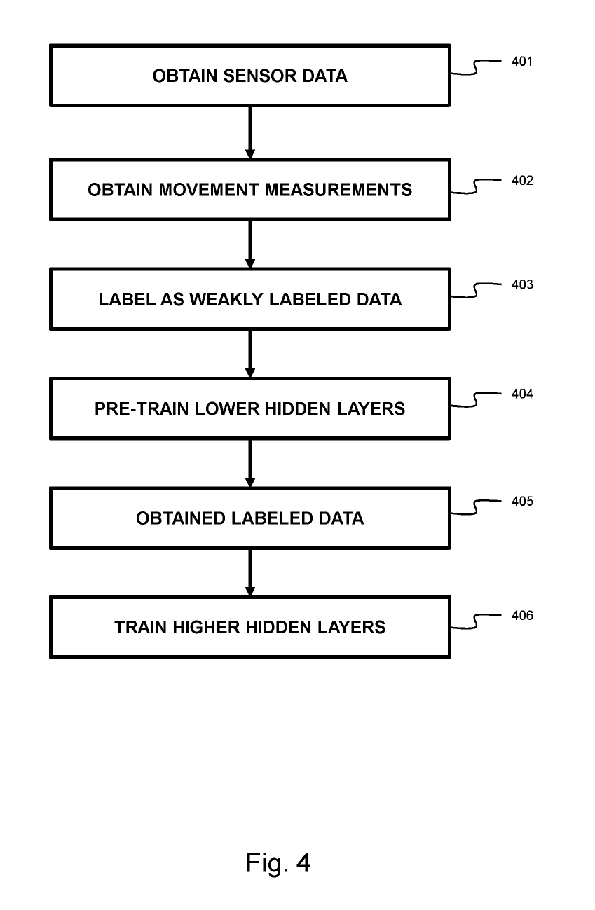

FIG. 4 illustrates steps to train the neural network 120, 220 according to an embodiment of the invention. In a first step 401 a first set of the sensor data 110 is obtained from the sensors of the mobile communication device. When this first set of sensor data 110 is obtained, also measurements according to one or more movements of the mobile communication device and thus of the user are obtained in step 402. In step 403, these measurements are then labelled with the first set of sensor data in order to obtain weakly labelled data, i.e., the measured movement of the user is thus related to the read out sensor at the time the movement occurred.

The weakly labelled data is then used to perform a first training of the lower hidden layers of the neural network, i.e., to perform a pre-training 404. In the pre-training 404 the lower hidden layers 121, 202 of the neural network are trained to estimate the measurements when the obtained sensor data is fed into the neural network. In order to do so, an output layer may be added to the neural network on top of the lower hidden layers 121, 202. The lower hidden layers 121, 202 are then trained in order to produce the weakly labelled data as output at the output layer.

Then, when the pre-training is completed, a second set of sensor data is obtained in step 405. Then, obtained movement behaviour of a user of the mobile communication device is labelled with this second set of sensor data. In the subsequent step 406, the neural network 120, 220 is then further trained to generate the desired movement behaviour as output 112, 204 from the labelled sensor data. In order to do so, the output layer added during the pre-training is removed. During the training step 406, the parameters in the higher hidden layers are then tuned to produce the labelled data when the input layer 201 is fed with the second set of sensor data. For the lower hidden layers, the parameters as obtained during the pre-training 404 are used. Optionally, also the parameters of the lower hidden layers may be further fine-tuned during the training step 406.

Deep learning architectures as known in the art generally need a lot of labelled training data. By the above pre-training 404, this need is mitigated by pre-training the deep neural network using weakly labelled data. As the weakly labelled data is highly correlated with the labelled data, the lower hidden layers in the neural network that learns to predict the weak labels during the pre-training 404, also indirectly learns to create an internal representation of the data which is useful when learning to predict the labelled data during the training step 406.

By the pre-training 404 the parameters in the lower hidden layers of the neural network are set to a value that is close to the optimal value that would have been obtained when using labelled data in the training step 406. These parameters may now be further fine-tuned afterwards together with the parameters of the higher hidden layers during the training step 406 by means of a smaller set of manually labelled samples. Thus, instead of needing a large set of labelled samples, only a large set of weakly labelled data and a small set of labelled data is needed. Preferably, the weakly labelled data is correlated with the labelled data as this will result in the best result, i.e., the smallest set of labelled data for training the higher hidden layers.

By the deep recurrent neural networks of FIG. 1, FIG. 2 and FIG. 3 and by the training sequence of FIG. 4 all the following actions needed for the prediction or estimation of movement behaviour are performed:
Pre-processing of the sensor data 110. This step may for example comprise noise removal, data interpolation and resampling, frequency filtering and gravity removal in case of accelerometer data.
Sensor fusion, i.e., the combination of multiple sensor data streams such as for example the accelerometer sensor data streams and gyroscope sensor data streams into a single, possibly multi-dimensional, data stream that contains the most descriptive characteristics of all input streams.
Sensor (auto-)calibration, i.e., the calibration of the sensor data in order to eliminate differences or artefacts that are inherent to manufacturing processes, communication devices or sensor brands, or the orientation at which the communication device is placed.
Feature description: This step entails the abstraction and dimensionality reduction of the sensor data to obtain meaningful feature values. For example, summing up the accelerometer values would result in a speed estimate that could be considered a meaningful feature for transport mode classification.
Classifier training: Features and their corresponding labels such as for example the transport mode are fed to a machine learning training algorithm that automatically generates the rules or tunes the classifier parameters that are needed to predict the label based on the feature values.

Pre-processing, sensor fusion and sensor calibration are needed because of differences in communication devices and sensor manufacturing processes, and due to fact that the orientation of the user's communication device, relative to the orientation of the person or vehicle, is usually not known such that it is hard to virtually align the sensor axes to the direction of movement. In solutions known in the art, complicated calibration procedures and signal processing techniques are therefore used to pre-process the sensor data and to estimate these unknown parameters in order to automatically calibrate the devices. Once calibrated, machine learning or rule-based techniques are then used to learn the structure and meaning of the data.

The neural network and training sequence according to the embodiments performs all these steps by a single algorithm, thereby removing or reducing the need for pre-processing, manually defined sensor fusion rules, hand crafted feature engineering, and sensor calibration. The proposed framework 100, i.e., neural network and method of training it, automatically learns how to fuse different sensor streams, how to remove noise and artefacts from the data, and how to calculate features that represent and abstract the raw sensor data in a meaningful manner.

According to an embodiment, weakly labelled data corresponds to a measure of the speed by a GPS. As the GPS speed is correlated with driving events such accelerations, brakes, turns, roundabouts and lane switches, GPS speed may be used for the estimation of movement behaviour such as driving events. By the pre-training step 404, the system will be able to predict or estimate speed by taking only accelerometer and gyroscope sensor data as its inputs and will thus have learned a meaningful representation of the data within the lower hidden layers of the neural network. This then serves as a basis for final fine-tuning, i.e., the training step 406, using a small set of labelled training data. By learning how to predict the driving speed based on sensor data, the deep recurrent neural network effectively learns how to fuse sensor data streams, how to normalize and calibrate the data, and how to detect driving events such as braking and accelerating. This knowledge on how the predict the driving speed is stored in the lower hidden layers 121 of the deep neural network 120. Once pre-training 404 is over, the upper layers 129 are removed from the network 120, and replaced by newly, untrained upper layers, whereas the lower layers stay in place and are now able to extract highly informative information from the raw sensor data. The higher hidden layers are then trained in step 406 by using a small set of labelled data, and the parameters of the lower hidden layers are fine-tuned in the same way.

In the context of movement type behaviour analysis, weakly labelled data may be easily gathered by moving around with a logging application installed on a smartphone. Different types of weak labels include, without being limited to, GPS speed or OBD-II data for vehicles, step-counters, and smartphone sensors that are not used as input to the neural network, e.g., magnetometer or barometer, heart beat sensors, blood pressure sensors, processing results from images and video, e.g., optical flow detection in dashcam video, etc.

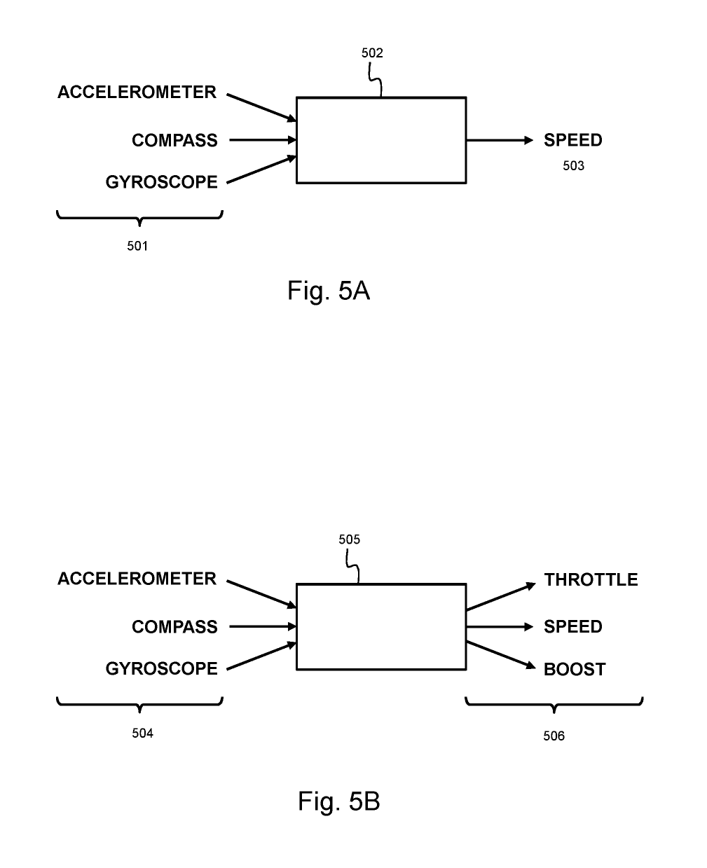

FIGS. 5A and 5B illustrate two examples for performing the pre-training 404 with weakly labelled data 503, 506 by a deep recurrent neural network according to the previous embodiments. According to FIG. 5A, accelerometer, compass and gyroscope sensors are sampled on a smartphone as sensor data 501, and fed into the lower hidden layers of a deep recurrent neural network 502. This network is then trained by weakly labelled readings 503 coming from a GPS system. The weak label in this case, is the speed 503 of the moving body which is related to the sampled sensor data. As such, the deep learning architecture 502 learns how to predict speed 503, by fusing its input sensors 501.

According to the example of FIG. 5B the same input sensors and thus input sensor data 504 are used to further predict the throttle and boost, apart from speed. In order to do so, the weak labels 506 may be read or measured from an OBD-II adaptor, attached to a car. As such, the deep learning network 505 learns how the raw input sensor values 504 relate to the engine and driving characteristics of the vehicle.

In both examples of FIGS. 5A and 5B, the system is pre-trained according to step 404 of FIG. 4 without any manual labelling process, i.e., the labelling may be done fully automated without manual intervention. The resulting pre-trained lower hidden layers of the neural network can then serve as a basis for more specific applications, e.g. to train a machine learning system to perform transport mode classification or to perform driving event detection.

Apart from speed, throttle and boost, derivatives of these measured data may be used as a weak label such as for example acceleration instead of speed. Furthermore other easily obtainable measurement may be used such as measurements than can be read out from a vehicle's communication bus such as the CAN bus.

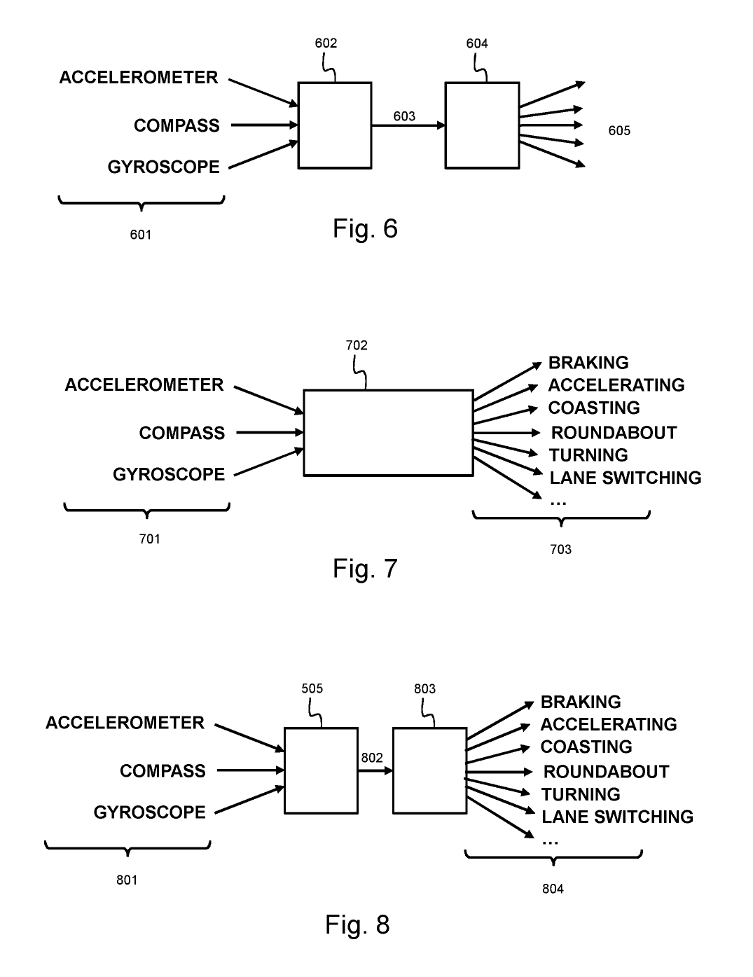

After the pre-training, as illustrated in FIG. 6, the neural network 602 thus ingests variable length, multi-dimensional sensor streams 601 as input, and outputs fixed length vector representations 603. To be able to do so, the neural network learns the temporal dependencies. This part of the neural network may thus be seen as an encoder or generic neural network component 602 which is equivalent to the set of lower hidden layers 121 of FIG. 1. An application specific neural network component 604 in the form of higher hidden layers can then be trained as a decoder which can parse these fixed-length vectors 603 and interpret them, in order to output a meaningful label 605, i.e., to estimate a movement behaviour such as for example a transport mode.

The following section describes two applications according to the present invention. In a first application, the general principles as outlined above with reference to FIG. 1-4 are applied to the detection and estimation of driving events and driving behaviour. In a second application, the same principles are applied to the detection and estimation of a transport mode of a user of a mobile communication device.

### Application 1: Driving Event and Behaviour Detection

According to the first application, driving events are predicted and estimated from the sensor input data. Driving events may for example comprise braking, accelerating, coasting, roundabout, turning, lane switching, driving over cobbles and driving over speed bumps. On top of that, driving behaviour may be modelled by assigning scores to the discrete driving events such as turning, accelerating and braking. The scores may then for example be indicative for driving aggressiveness, traffic insight and legal behaviour.

Manually labelling driving events and driving behaviour is however cumbersome and thus difficult for large sets of transport sessions. Therefore, the pre-trained neural network according to the embodiments of FIG. 5A or FIG. 5B are used to parse the input sensor data, perform sensor fusion, and generate meaningful features. To achieve the specific goal of driving event detection, the neural network is then further trained by means of a small, manually labelled dataset.

FIG. 7 illustrates a first way for further fine-tuning and thus training the neural network according to step 406. In this case, the neural network 505 is retrained to neural network 702 but now with the manually labelled data as output 703. Neural network 702 is thus further trained to generate the labelled driving events from sensor input data 701. Optionally, the top layers of the neural network 505 may be removed and extra layers can be added to the neural network. The parameters of the neural network 702 are thus not initialized with random values but by the values obtained after pre-training the neural network 505 using the weakly labelled data according to step 404.

FIG. 8 illustrates a second way for further fine-tuning and thus training the neural network according to step 406. In this case, the pre-trained neural network 505 from FIG. 5B is used as is or, optionally, the output layer of the neural network 505 can first be removed. The output of the network 505 is then used as input 802 of a second deep neural network component 803 that will be trained according to step 406 for estimating or detecting driving events 804. In other words, the specific neural network component 803 is thus stacked on top of the general neural network component 505, wherein neural network component 803 comprises the higher hidden layers and the general neural network component 505 comprises the lower hidden layers.

The embodiment of FIG. 8 illustrates the advantage of first pre-training a general framework, i.e., neural network component 505. With this approach, multiple specific frameworks and thus neural network components can be stacked directly on top of this general neural network 505. One example of such a specific neural network component is the driving event detection component 803.

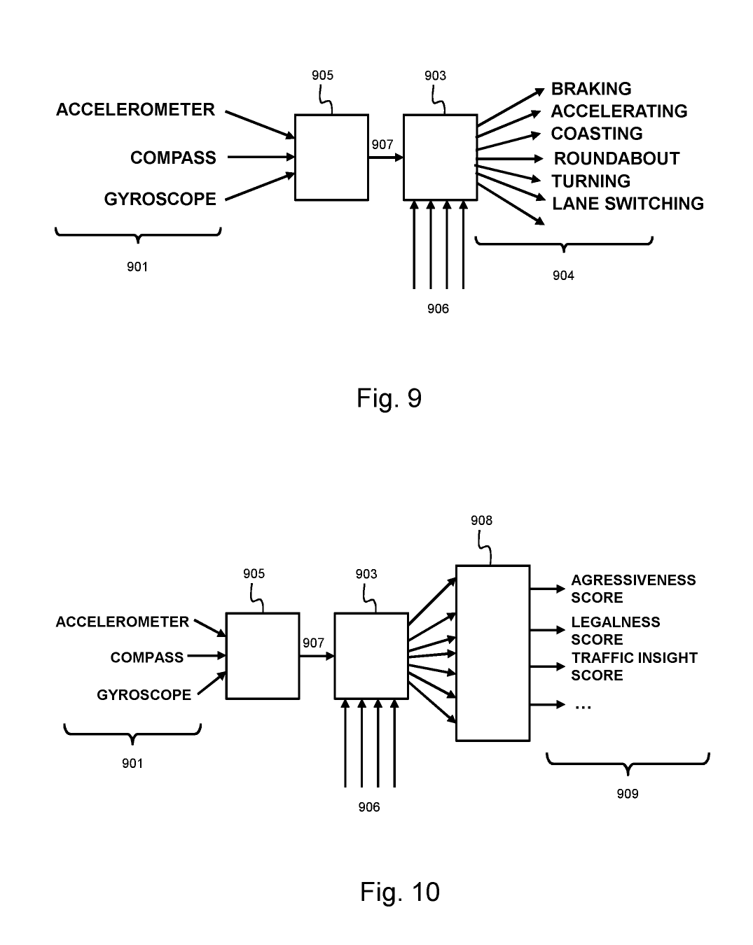

FIG. 9, illustrates a framework based on neural networks according to a further embodiment. Similar to FIG. 8, it comprises a first neural network component 905 that is pre-trained according to step 404 for estimating the measured weakly-labelled data 907 from the input sensor data 901. It also comprises a second neural network component 903 that is stacked on top of the first component 905. This second component is trained according to step 406 with manually labelled data to estimate the driving events 904 from the intermediate data 907. In the embodiment of FIG. 9, the neural network component 903 further combines the inputs 907 with external data or features 906 such as for example road type information and weather forecast. External data 906 is thus not sensor data acquired from the user's mobile communication device.

FIG. 10 illustrates an extension to the embodiment of FIG. 9 where an additional neural network component 908 is stacked on top of neural network components 903. By a small set of manually labelled data, this component 908 is then trained according to step 406 to predict or estimate the driving behaviour 909 from the driving events 904.

### Application 2: Transport Mode Detection

Detecting a user's transport mode based on sensor data from the user's mobile communication device usually requires specialized machine learning algorithms that are trained using large amounts of manually labelled data which is often difficult to obtain.

As after the pre-training step 404, the neural network components 502, 505 of FIG. 5 can estimate the user's speed based on sensor input 501, 504, the learned internal representation of the data may further be used to estimate the transport mode of the user. To accomplish this, the neural network components 702, 803 and 903 are trained according to step 406 to estimate the transport mode of a user instead of a driving event.

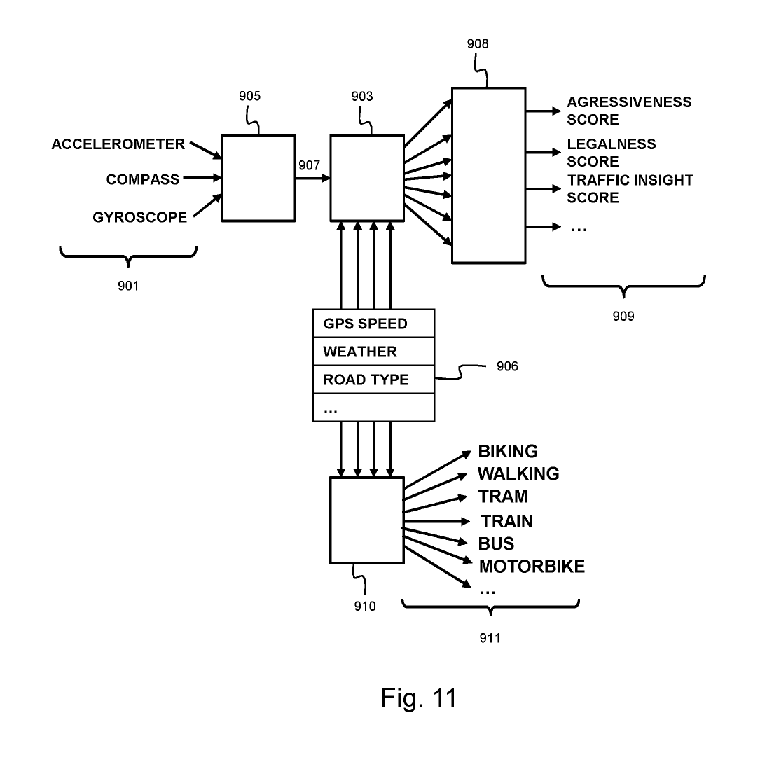

FIG. 11 illustrates a further extension of the system of FIG. 10 where an additional neural network component 910 is added on top of the neural network component 905. In this case, neural network components 905 and 910 are pre-trained according to step 406, possibly after removing the top layer(s) of the neural network 905, using a small amount of labelled data. However, instead of randomizing the neural network parameters of neural network component 905 before training, the parameters are initialized to the same values as obtained after pre-training step 404. This allows the specific transport mode detection component 910 to quickly fine-tune these parameters based on only a few labelled data samples.

According to the above embodiments, a fixed set of sensors (accelerometer, gyroscope, compass) were used as input for neural network. However, different sensors types such as barometer, light sensor, etc. may also be used.

An important advantage of the above embodiments of the invention is multiple tasks such as for example transport mode classification, driver behaviour estimation, movement event detection can be performed without the need for large amounts of manually labelled training data for each of these tasks.

To be able to perform different types of tasks, during the pre-training a general representation of the sensor input data is learned. This representation is not optimized towards a single task, i.e., to the estimation of a specific type of movement behaviour, but is generalized to be usable for different types of tasks, i.e., for the estimation of different types of movement behaviour. By stacking further neural network layers on the pre-trained neural network, the structure of and relations between sensor streams are learned in a hierarchical manner. At a lowest level of the hierarchy, sensor streams are fused and aggregated to detect movement related events such as ‘accelerating’, ‘braking’, ‘turning’ and ‘coasting’ on the lowest levels of this hierarchy. Higher up in the hierarchy, the neural network again aggregates these events into more complicated actions such as ‘switching lanes’, ‘taking a roundabout’, ‘driving over cobbles’, etc. In the highest levels of the hierarchy, abstract concepts such as ‘dangerous driving’ or ‘good traffic insight’ may be learned by further aggregating lower level features.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-15. (canceled)

16. A computer-implemented method for estimating movement behaviour of a user of a mobile communication device by a neural network comprising one or more lower and one or more higher hidden layers; said method further comprising the following steps:
obtaining sensor data from one or more sensors in said mobile communication device; and
obtaining measurements related to a movement of said user; and
labelling said measurements as weakly labelled data with a first set of said sensor data; and
pre-training said one or more lower hidden layers to estimate said measurements from said first set of sensor data in order to estimate said movement of said user; and
obtaining a second set of said sensor data; wherein movement behaviour of said user is labelled with said second set as labelled data; and
training said one or more higher hidden layers in said neural network with said labelled data to estimate said movement behaviour of said user as said output.

17. Method according to claim 16 wherein said training further comprises training said one or more lower hidden layers in said neural network.

18. Method according to claim 16 comprising:
before said pre-training, stacking an output layer on top of said one or more lower hidden layers for calculating said movement of said user; and
after said pre-training, removing said output layer and stacking said one or more higher hidden layers on said one or more lower hidden layers.

19. Method according to claim 16 comprising:
after said pre-training, removing one or more top layers of said lower hidden layers.

20. Method according to claim 16 wherein said sensors comprise an accelerometer and/or a compass and/or a gyroscope.

21. Method according to claim 16 wherein said measurements comprise at least one of the group of:
a speed measurement;
a throttle measurement of a throttle position of a transportation means operated by said user;
an engine's RPM or revolutions per minute measurement.

22. Method according to claim 16 wherein said estimating movement behaviour comprises estimating a driving event.

23. Method according to claim 19 wherein said driving event is one of the group of braking, accelerating, coasting, taking roundabout, turning and lane switching.

24. Method according to claim 16 wherein said estimating movement behaviour comprises estimating a transport mode of said user.

25. Method according to claim 16 wherein said neural network is a deep neural network comprising at least two of the group of a long-short-term memory neural network component, a convolutional neural network component, and a feed forward neural network component as said lower and/or higher hidden layers.

26. Method according to claim 16 wherein said movement behaviour comprises a first and second type of movement behaviour; and
wherein said higher hidden layers comprise a first and second higher set of said hidden layers outputting respectively said first or second type of movement behaviour as output; and
wherein first and second movement behaviour of said user is labelled with said second set as respectively first and second labelled data; and
wherein said training comprises training said first and second higher set of said hidden layers with respectively said first and second labelled data.

27. Method according to claim 16 wherein said training and pre-training further comprise fine-tuning respectively parameters of said higher and lower hidden layers.

28. A computer program product comprising computer-executable instructions for performing the method according to claim 16 when the program is run on a computer.

29. A computer readable storage medium comprising the computer program product according to claim 28.

30. A data processing system programmed for carrying out the method according to claim 16.
